(19) United States
(12) Patent Application Publication
(10) Pub. No.: US 2026/0300002 A1
(43) Pub. Date: Oct. 1, 2026

(54) INFRASTRUCTURE TEST EXECUTION SUPPORT SYSTEM AND INFRASTRUCTURE TEST EXECUTION SUPPORT METHOD

(71) Applicant: Hitachi, Ltd., Tokyo (JP)

(72) Inventors: Yosuke HIMURA, Tokyo (JP); Hitoshi YABUSAKI, Tokyo (JP); Darshan CHAWDA, Tokyo (JP); Takaya IDE, Tokyo (JP)

(21) Appl. No.: 19/309,442

(22) Filed: Aug. 25, 2025

(30) Foreign Application Priority Data
Mar. 31, 2025 (JP) 2025-060140

(51) Int. Cl. G06F 9/48; G06F 11/263

(52) U.S. Cl. CPC G06F 9/4881; G06F 11/263

(57) ABSTRACT

It is possible to make the suppression of a decrease in the number of executions of a test case and a reduction in a test execution time compatible. Provided is an infrastructure test execution support system that is executed by a computer including a processor and a memory and supports the execution of a test relevant to the infrastructure of a system, in which the processor specifies an execution order of two or more test cases, on the basis of similarity information of a system state between two test cases, which is the similarity information between an intermediate state of the system in a first test case and a previous state of the system in a second test case.

### CROSS-REFERENCE TO PRIOR APPLICATION

This application relates to and claims the benefit of priority from Japanese Patent Application number 2025-060140, filed on Mar. 31, 2025, the entire disclosure of which is incorporated herein by reference.

### BACKGROUND OF THE INVENTION

### 1. Field of the Invention

The present invention relates to an infrastructure test execution support system and an infrastructure test execution support method.

### 2. Description of the Related Art

The importance of continuously ensuring the security of an IT system has increased. For example, perimeter defense has been insufficient in order to ensure the security against a vulnerability attack by ransomware via an internal network. In such circumstances, it is important to sequentially update the infrastructure of the IT system in order to handle the vulnerability of a software infrastructure that is continuously and unexpectedly found. Accordingly, the importance of the repeated system test has also increased, but the system test is difficult to handle only manually, and thus, is required to be automated.

On the other hand, in order to ensure the reliability of the IT system, it is desirable to perform a reliability test (a fault test) in various fault patterns. In the cloud, the reliability is not transparently secured by hardware, and countermeasures against various redundancies are required for a user, but in order to reduce a burden on such countermeasures, the importance of an infrastructure fault test has also increased. However, there is a problem that it takes time to execute the infrastructure fault test in various fault patterns. As a technology for solving such a problem, for example, International Publication No. WO2016/016975 is provided. In International Publication No. WO2016/016975, an important test case is extracted in accordance with the development status of a program, the status of a test, and the like.

### SUMMARY OF THE INVENTION

In International Publication No. WO2016/016975, the important test case can be extracted in accordance with the development status of the program, the status of the test, and the like. However, simply extracting or prioritizing the important test case may cause a decrease in the number of executions of the test case, for example, in a case where there is a constraint on the total execution time. In particular, the reliability test is likely to take time, and the number of executions of the test case is likely to decrease. In addition, a method for executing the test by individually constructing and preparing the system for each test case is also considered, but there is a constraint such as the upper limit in a resource, or the cost increases. Therefore, a technology has been required in which the suppression of a decrease in the number of executions of the test case and a reduction in a test execution time can be compatible.

Therefore, an object of the invention is to provide a technology in which the suppression of a decrease in the number of executions of a test case and a reduction in a test execution time can be compatible.

An infrastructure test execution support system according to the invention is configured as an infrastructure test execution support system that is executed by a computer including a processor and a memory and supports execution of a test relevant to an infrastructure of a system, in which the processor specifies execution order of two or more test cases, on the basis of similarity information of a system state between two test cases, which is the similarity information between an intermediate state of the system in a first test case and a previous state of the system in a second test case.

According to the invention, it is possible to make the suppression of a decrease in the number of executions of the test case and a reduction in the test execution time compatible.

### BRIEF DESCRIPTION OF THE DRAWINGS

FIG. 1 is a diagram illustrating an example of a configuration of a system to which an infrastructure test execution support system that is one example of the invention is applied;

FIG. 2 is a diagram illustrating an example of a hardware configuration of a management server;

FIG. 3 is a diagram for illustrating an example of a test case;

FIG. 4 is a diagram for illustrating a processing flow and a system state when assuming the test case illustrated in FIG. 3;

FIG. 5 is a diagram for illustrating processing that is skipped in the processing flow and the system state illustrated in FIG. 4;

FIG. 6 is a diagram illustrating an example of a functional configuration of the management server;

FIG. 7 is a diagram illustrating an example of a system configuration information temporary management table;

FIG. 8A is a diagram illustrating an example of a fault definition table;

FIG. 8B is a diagram illustrating an example of a behavior-under-fault definition table;

FIG. 8C is a diagram illustrating an example of a state acquisition setting method definition table;

FIG. 8D is a diagram illustrating an example of a system requirements definition table;

FIG. 9 is a diagram illustrating an example of a test case management table;

FIG. 10 is a diagram illustrating an example of a test constraint condition management table;

FIG. 11 is a diagram illustrating an example of a test case execution order management table;

FIG. 12 is a flowchart illustrating an example of a processing procedure of processing that is executed by the management server in this example;

FIG. 13 is a flowchart illustrating an example of a processing procedure of detailed processing of S1201 illustrated in FIG. 12;

FIG. 14 is a flowchart illustrating an example of a processing procedure of detailed processing of S1202 illustrated in FIG. 12;

FIG. 15 is a flowchart illustrating another example of the processing procedure of the detailed processing of S1202 illustrated in FIG. 12;

FIG. 16 is a diagram illustrating an example of a pair temporary management table;

FIG. 17 is a flowchart illustrating an example of a processing procedure of detailed processing of S1203 illustrated in FIG. 12; and

FIG. 18 is a diagram illustrating an example of a display screen output by this system.

### DETAILED DESCRIPTION OF THE PREFERRED EMBODIMENTS

Hereinafter, the embodiment of the invention will be described with reference to the drawings. Examples are merely illustrative for describing the invention, and may be suitably omitted and simplified for the sake of clarity of explanation. The invention can be carried out even in various other forms. Unless otherwise specified, each constituent may be singular or plural. In order to facilitate the understanding of the invention, the position, the size, the shape, the range, and the like of each constituent illustrated in the drawings may not represent the actual position, size, shape, range, and the like. Therefore, the invention is not necessarily limited to the position, the size, the shape, the range, and the like disclosed in the drawings.

As an example of various types of information, the information may be described in expressions such as “table”, “list”, and “queue”, but various types of information may be expressed in a data structure other than the above. For example, various types of information such as “XX table”, “XX list”, and “XX queue” may be “XX information”. When describing identification information, expressions such as “identification information”, “identifier”, “name”, “ID”, and “number” are used, and the expressions can be replaced with each other.

In a case where there are a plurality of constituents having the same or similar function, the constituents may be described by applying different subscripts to the same numerical number. In addition, in a case where it is necessary to distinguish such a plurality of constituents, the constituents may be described by omitting the subscripts.

In the examples, processing that is performed by executing a program may be described. Here, a computer executes a program by a processor (for example, a CPU and a GPU), and performs processing defined by the program while using a storage resource (for example, a memory), an interface device (for example, a communication port), or the like. Therefore, the subject of the processing that is performed by executing the program may be the processor. Similarly, the subject of the processing that is performed by executing the program may be a controller, a device, a system, a computer, or a node including the processor. The subject of the processing that is performed by executing the program may be an arithmetic unit, and may include a dedicated circuit performing specific processing. Here, the dedicated circuit, for example, is a field programmable gate array (FPGA), an application specific integrated circuit (ASIC), a complex programmable logic device (CPLD), or the like.

The program may be installed in the computer from a program source. The program source, for example, may be a storage medium that can be read out by a program distribution server or the computer. In a case where the program source is the program distribution server, the program distribution server may include the processor and the storage resource storing a distribution target program, and the processor of the program distribution server may distribute the distribution target program to other computers. In addition, in the examples, two or more programs may be attained as one program, or one program may be attained as two or more programs.

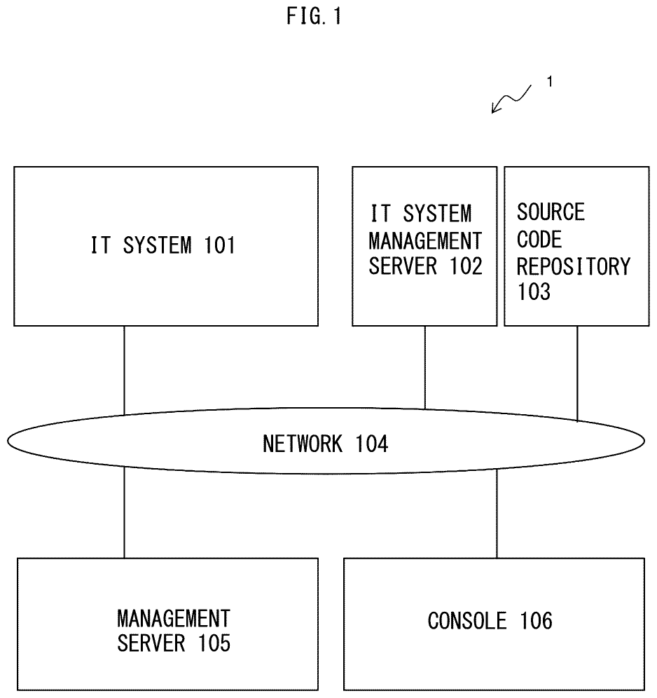

FIG. 1 is a diagram illustrating an example of the configuration of a system 1 to which an infrastructure test execution support system that is one example of the invention is applied. The system 1 includes an IT system 101, an IT system management server 102, a source code repository 103, a management server 105, and a console 106, which are connected to each other via a network 104 such that communication is available.

The IT system 101 is a server in which a general IT system such as a Web system is constructed. The IT system 101 is managed by the IT system management server 102. The IT system management server 102 is a server that manages the IT system 101. The IT system management server 102 manages the operating state or the like of the IT system 101.

The source code repository 103 is a server that manages a source code or a system configuration for operating the IT system 101. The system configuration, for example, includes information that characterizes the system such as the type or the version of an operating system or an application, the clock frequency of a CPU used as hardware, the size of a memory, and the capacity of a database. The management server 105 is a server that manages the entire system 1. The management server 105 manages the operation of the infrastructure test execution support system in this example.

The console 106 is a management terminal to be used by an administrator of the system 1. Note that a general network such as the internet may be used as the network 104.

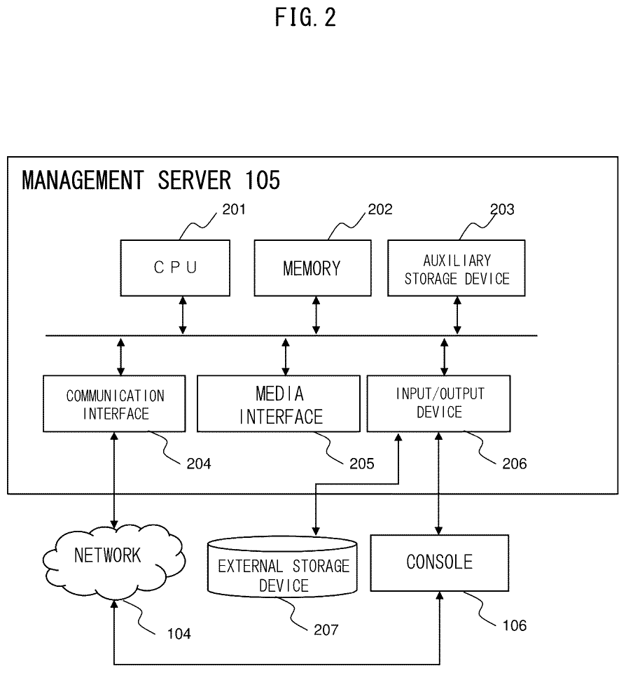

FIG. 2 is a diagram illustrating an example of the hardware configuration of the management server 105. As illustrated in FIG. 2, the management server 105, for example, can be attained by a computer that includes a CPU 201, a memory 202, an auxiliary storage device 203 such as a read only memory (ROM), a communication interface 204 for connecting to a communication network, such as a network interface card (NIC), a media interface 205 reading and writing information with respect to a storage medium having mobility, such as a compact disk (CD) or a USB memory, a device receiving the input of various types of information, such as a keyboard, a mouse, a reader, and a scanner, and an input/output device 206 including a display or the like outputting various types of information that is input and used for processing, as illustrated in FIG. 2, in which such constituents are connected to each other by an internal communication line such as a system bus.

In addition, the management server 105 is connected to the console 106 manipulated by the administrator or an external storage device 207 such as a hard disk drive (HDD) via various networks such as the network 104.

Various types of data that is stored in the management server 105 or used for processing can be attained by the CPU 201 reading out the data from the auxiliary storage device 203 or the external storage device 207 and using the data. In addition, each function of the management server 105 can be attained by the CPU 201 loading a predetermined program stored in the auxiliary storage device 203 or the external storage device 207 on the memory 202 and executing the program.

The predetermined program or the data described above may be downloaded from a predetermined storage medium via the media interface 205 or from a network via the communication interface 204, loaded on the memory 202, and executed by the CPU 201. In addition, the predetermined program or the data may be directly loaded on the memory 202 from the predetermined storage medium via the media interface 205 or from the network via the communication interface 204, and executed by the CPU 201.

Hereinafter, a case where the management server 105 is composed of one computer will be exemplified, but all or a part of the functions may be provided by being distributed in one or a plurality of computers such as a cloud, and the same functions may be attained by communicating with each other via a network. The same may be considered for the other servers or systems illustrated in FIG. 1.

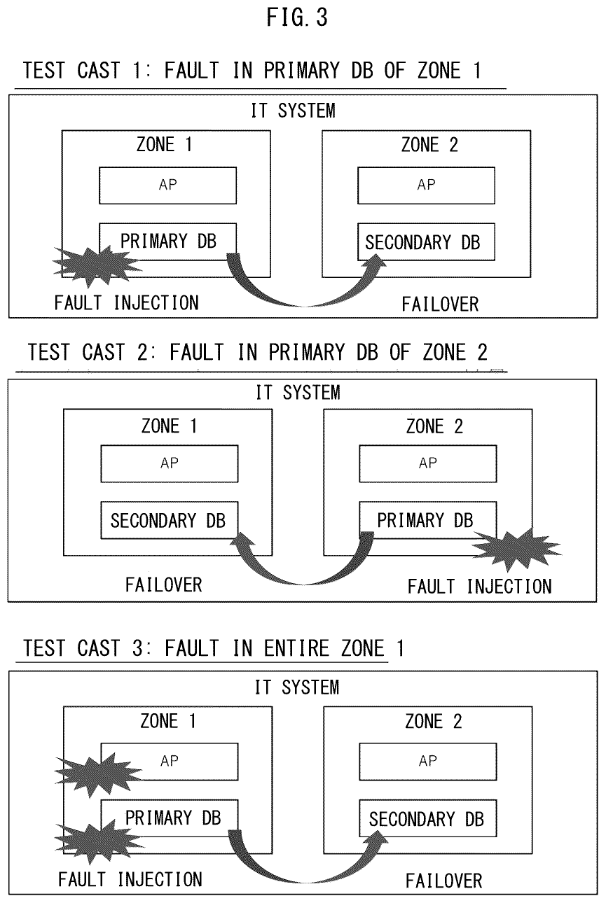

FIG. 3 is a diagram for illustrating an example of a test case. In FIG. 3, three test cases assumed in the infrastructure test execution system that is executed by the management server 105 are exemplified. As the test case, in order to intentionally cause a fault in the IT system 101, a fault injection is performed on any of a plurality of zones (in this example, a zone 1 and a zone 2) configuring the IT system 101.

First, as a test case 1, it is considered that in the zone 1 including an application (AP) and a primary data base (DB), a fault injection is performed on the primary DB, and a failover is caused to a secondary DB of the zone 2. As a test case 2, it is considered that in the zone 2 including an application and a primary DB, a fault injection is performed on the primary DB, and a failover is caused to a secondary DB of the zone 1. As a test case 3, it is considered that a fault injection is performed on the entire zone 1 described above, that is, both of the application and the primary DB, and a failover is caused to the zone 2.

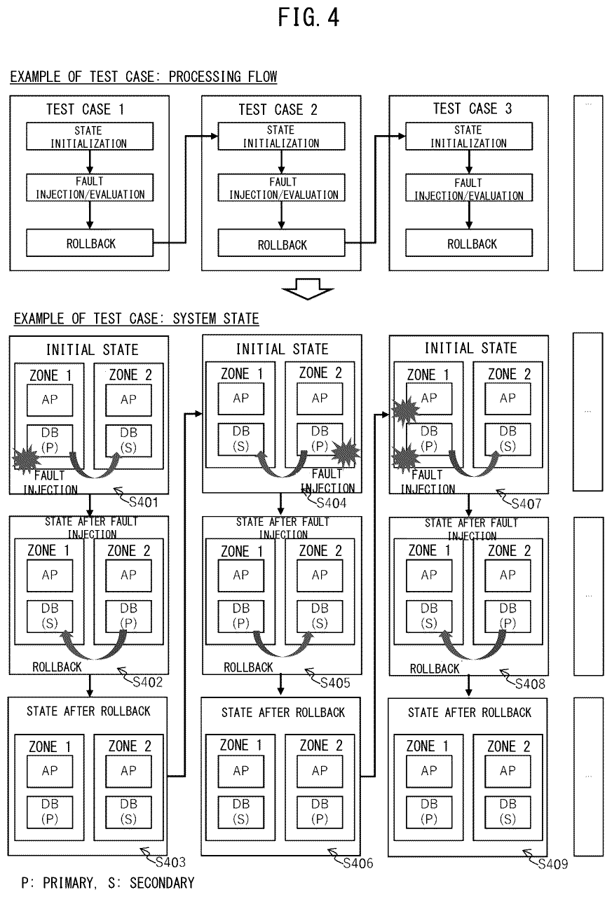

FIG. 4 is a diagram for illustrating a processing flow and a system state when assuming the test case illustrated in FIG. 3. As illustrated in the upper part of FIG. 4, first, for each of the zone 1 and the zone 2, the state of the application and the DB configuring each zone is initialized, the test of the test case 1 is executed, the fault injection and evaluation are performed, and rollback is performed to return to a state before the fault injection.

After the rollback of the test case 1 is performed, in order to execute the test of the test case 2, the state of the application and the DB is initialized, and the fault injection the and evaluation, and the rollback are performed, as with the test case 1. Similarly, for the test case 3, the state of the application and the DB is initialized, and the fault injection and the evaluation, and the rollback are performed.

As illustrated in the lower part of FIG. 4, the system state in a case where the test is performed in such a processing flow transitions as follows. First, in the initial state of the test case 1, in a case where the fault injection is performed on the primary DB of the zone 1, the primary DB fails over to the secondary DB and takes over the data (S401). Then, in a state after the fault injection, the secondary DB that has taken over the data is the primary DB, and rolls back a transaction or a manipulation on the transferred DB to the secondary DB, that is, the primary DB of the zone 1 (S402). After the processing of S402, the state is in a state after the rollback, and the primary DB of the zone 1 is in a state where a transaction or a manipulation on the primary DB of the zone 2 in S402 is reflected (S403). Similarly, for the test case 2 and the test case 3 subsequent to the test case 1, the system state transitions (S404 to S406 and S407 to S409).

In a case where the test is performed in such a plurality of test cases, in this example, as described below, for example, when the state after the fault injection and a state before the fault injection are the same between the test cases, shortcut processing is set in which transition to initialization processing from the consecutive rollback is skipped.

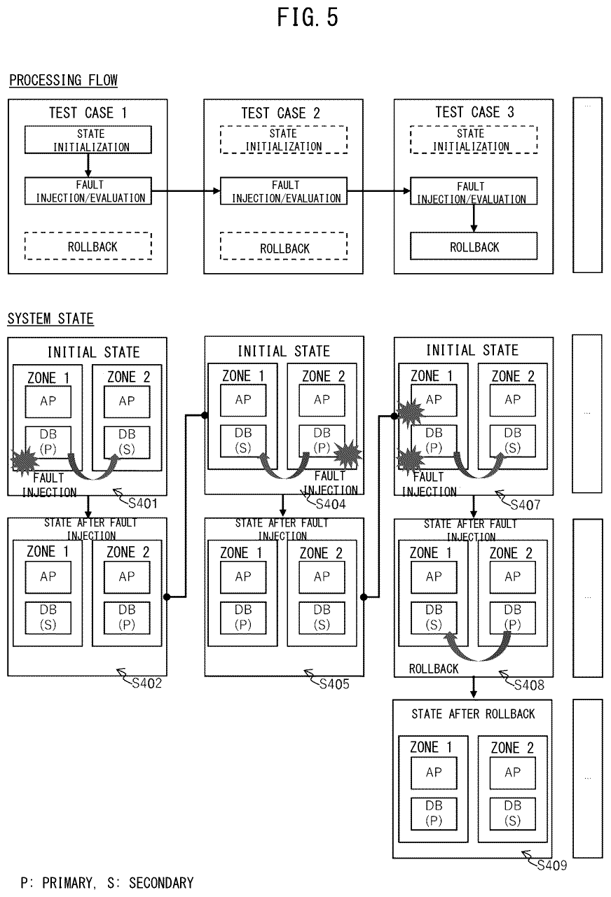

FIG. 5 is a diagram for illustrating processing that is skipped in the processing flow and the system state illustrated in FIG. 4. FIG. 5 illustrates that each of rollback when proceeding to the test case 2 from the test case 1 (S403) and rollback when proceeding to the test case 3 from the test case 2 (S406) is skipped in the processing flow and the system state illustrated in FIG. 4. Therefore, in this example, as illustrated in the processing flow, in a case where the state initialization, the fault injection, and the evaluation are performed on the test case 1, the rollback is performed after the fault injection and the evaluation are performed on the test case 2, and the fault injection and the evaluation are performed on the test case 3.

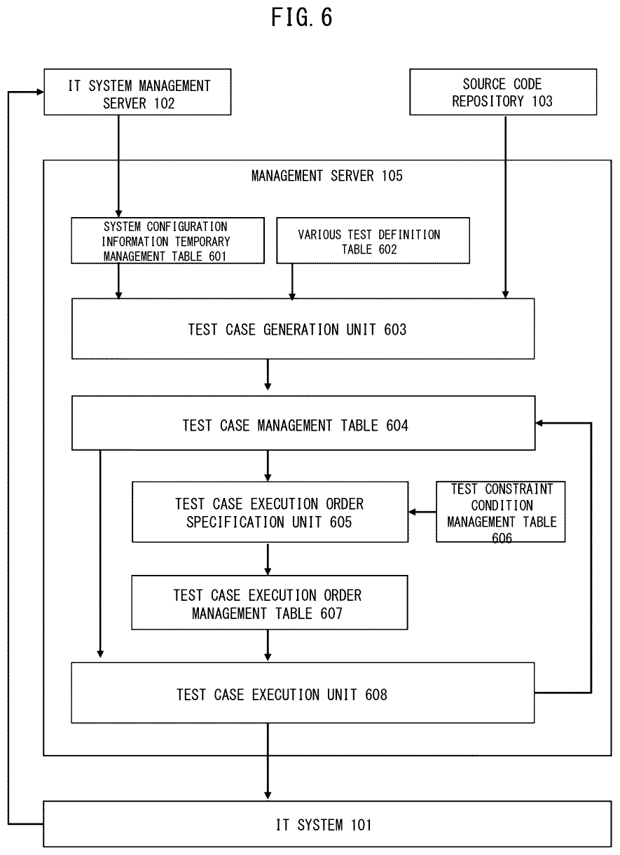

FIG. 6 is a diagram illustrating an example of the functional configuration of the management server 105. In order to execute the processing illustrated in FIG. 5, the management server 105 includes a system configuration information temporary management table 601 and a various test definition table 602. The system configuration information temporary management table 601 is acquired from the IT system management server 102. The various test definition table 602 is stored in advance.

In addition, the management server 105 includes a test case generation unit 603. The test case generation unit 603 inputs in which a source code describing a configuration for operating the IT system 101 or information relevant to the system configuration, which is acquired from the system configuration information temporary management table 601, the various test definition table 602, and the source code repository 103, and outputs and retains a test case management table 604.

Further, the management server 105 includes a test case execution order specification unit 605 that is for specifying an execution order of the test case by using a test constraint condition management table 606 stored in the server and generating a test case execution order management table 607, and a test case execution unit 608 that is for executing the test case by using the test case execution order management table 607. The test case execution unit 608 executes the test case on the IT system 101, and feeds back a test result of the executed test case to the test case management table 604.

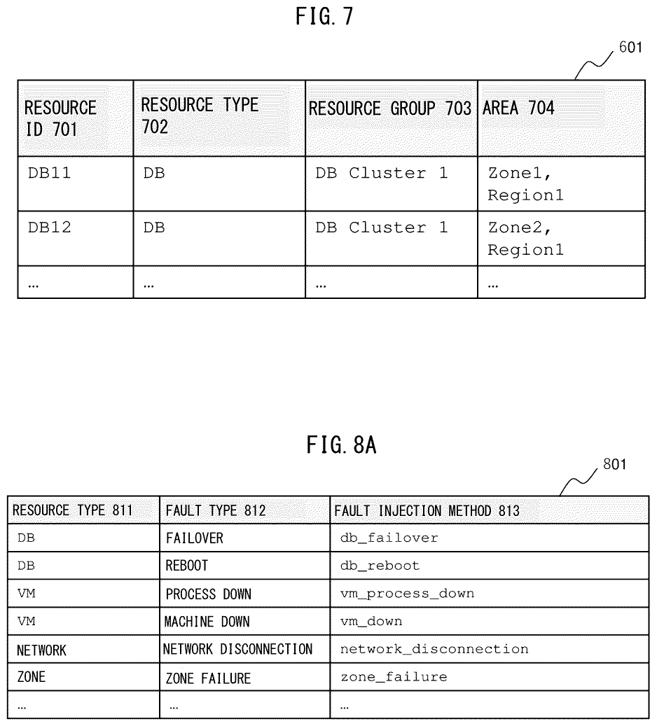

FIG. 7 is a diagram illustrating an example of the system configuration information temporary management table 601. The system configuration information temporary management table 601 is information indicating the configuration of the IT system 101 when executing the processing of this system, and can be acquired from the IT system management server 102 or the source code repository 103. The system configuration information temporary management table 601 is also used when determining whether the test case is required to be updated.

As illustrated in FIG. 7, in the system configuration information temporary management table 601, a resource ID 701 for identifying a resource in the IT system 101, a resource type 702 indicating the type of resource identified by the resource ID 701, a resource group 703 indicating a group to which the resource identified by the resource ID 701 belongs, and an area 704 indicating region in which the resource identified by the resource ID 701 is retained are stored in association with each other. FIG. 7, for example, illustrates that a resource of which the resource ID 701 is “DB11” has the resource type 702 of “DB” (database), and the resource belongs to the resource group 703 of “DB Cluster 1” under the control of the area 704 of “Zone 1, Region 1”.

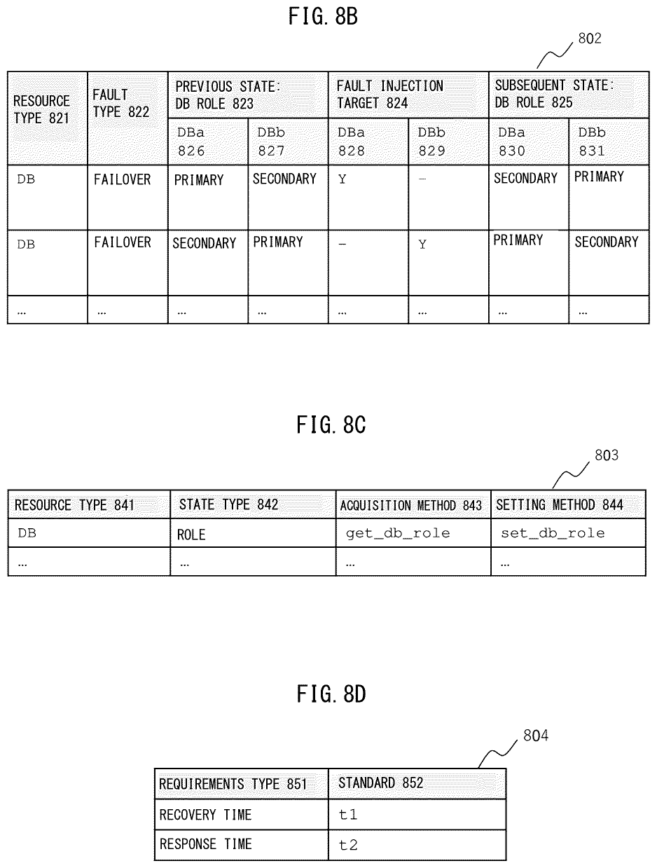

FIG. 8A is a diagram illustrating an example of a fault definition table 801. FIG. 8B is a diagram illustrating an example of a behavior-under-fault definition table 802. FIG. 8C is a diagram illustrating an example of a state acquisition setting method definition table 803. FIG. 8D is a diagram illustrating an example of a system requirements definition table 804. Such tables illustrated in FIGS. 8A to 8D configure the various test definition table 602 illustrated in FIG. 6.

The fault definition table 801 is a table defining a fault in the resource of the IT system 101. As illustrated in FIG. 8A, in the fault definition table 801, a resource type 811 indicating the type of resource, a fault type 812 indicating the type of fault in the resource type, and a fault injection method 813 with respect to the resource of the resource type are stored in association with each other. FIG. 8A, for example, illustrates that in a case where a fault of a fault type “failover” is injected to the resource type “DB”, the injection is performed by a fault injection method “db_failover”.

The behavior-under-fault definition table 802 is a table defining the behavior of a resource to which a fault is injected. As illustrated in FIG. 8B, the behavior-under-fault definition table 802 includes a resource type 821 similar to the resource type 811 illustrated in FIG. 8A, and a fault type 822 similar to the fault type 812, in which in association with such items, a previous state 823 indicating a state before a fault is injected to the resource, a fault injection target 824 indicating a resource to be a candidate of a fault injection target, and a subsequent state 825 indicating a state after the fault is injected to the resource are stored in association with each other. FIG. 8B, for example, illustrates that in a case where the fault of the fault type “failover” is injected to the resource type “DB” (a pattern of the first record), the previous state is defined such that DBa is “primary” and DBb is “secondary”, and in a case where the fault is injected to DBa (“Y”), the subsequent state is defined such that DBa is “secondary” and DBb is “primary”. Note that DBa corresponds to DB11 illustrated in FIG. 8A, and DBb corresponds to DB12 illustrated in FIG. 8A. This example is described on the premise that there is one primary DB and one secondary DB, but there may be a plurality of primary DBs and a plurality of secondary DBs. For example, in a case where there are four DBs, among four DBs, two DBs may be configured as the primary DB, and the other two DBs may be configured as the secondary DB, and the previous state or the subsequent state, and the fault injection target may be defined for each of the DBs. Accordingly, each state can be defined for each DB.

The state acquisition setting method definition table 803 is a table defining a method for acquiring and setting the state of the resource. As illustrated in FIG. 8C, in the state acquisition setting method definition table 803, a resource type 841 indicating the type of resource of which the state is acquired and set, a state type 842 indicating the type of state of the resource, an acquisition method 843 for acquiring the state of the type, and a setting method 844 for setting the acquired state of the type are stored in association with each other. FIG. 8C, for example, illustrates that in a case where a state type “role” is acquired for the resource type “DB”, the acquisition is performed by an acquisition method “get_db_role”. In addition, it is illustrated that in a case where the state type is set, the setting is performed by a setting method “set_db_role”.

The system requirements definition table 804 is a table defining requirements when a fault occurs in the IT system 101. As illustrated in FIG. 8D, in the system requirements definition table 804, a requirements type 851 indicating the type of requirements of the system and a standard 852 of the requirements of the type are stored in association with each other. FIG. 8D, for example, illustrates that as a recovery time in a case where a fault occurs in the IT system 101, “t1” is defined as the requirements, and as a response time, “t2” is defined as the requirements. That is, in a case where a fault occurs in the IT system 101, it is required to satisfy such requirements.

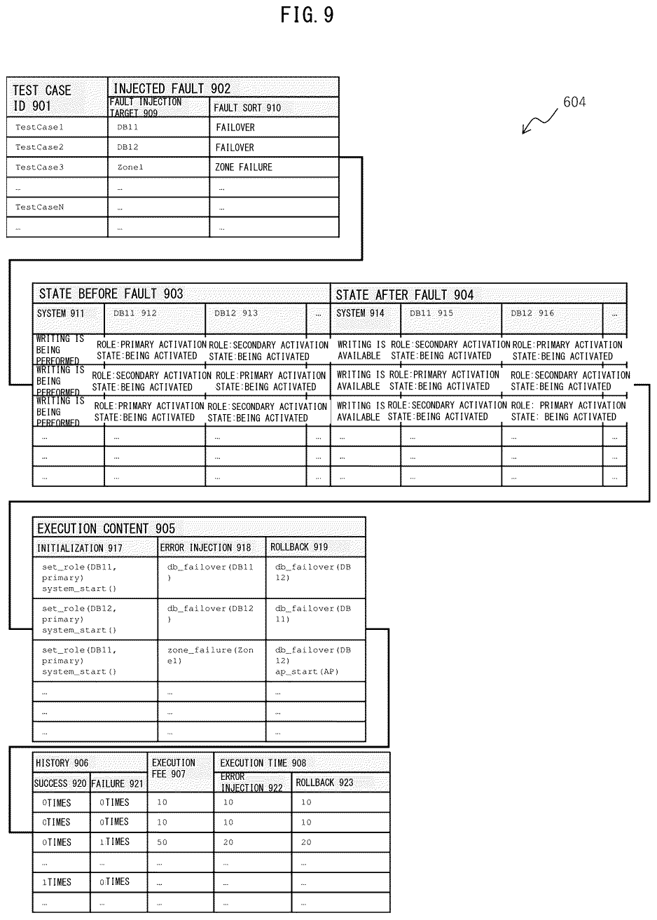

FIG. 9 is a diagram illustrating an example of the test case management table 604. The test case management table 604 is a table for managing the test case of the IT system 101. As illustrated in FIG. 9, in the test case management table 604, a test case ID 901 for identifying a test case, a fault sort 910 indicating a fault injection target 909 that is a resource to be the fault injection target and the sort thereof, a state before fault 903 indicating the state of the system and the resource before the fault injection, a state after fault 904 indicating the state of the system and the resource after the fault injection, an execution content 905 indicating the specific content of the test case, a history 906 indicating the result of a test executed by the content indicated in the execution content 905, an execution fee 907 indicating a fee when the test is executed, and an execution time 908 when the test is executed are stored in association with each other. Here, as an example, as the state before fault, the system (the IT system 101) and the DB (the DB configuring the IT system 101) are stored as the states before and after fault. In addition, as an example of the execution content, initialization, an error injection, and rollback are stored. A state where the initialization, the error injection, and the rollback are executed corresponds to the initial state, the state after fault injection, and the state after rollback of the test case illustrated in FIG. 5.

FIG. 9, for example, illustrates that a test case ID “TestCase 1” is a test for injecting a fault that causes a failover on DB11, and as the state before the fault, the IT system 101 is in a state where writing is being performed on DB11 activated as the primary DB and DB12 activated as the secondary DB. In addition, it is illustrated that as the state after the fault, the IT system 101 is in a state where writing is available to DB11 activated as the secondary DB and DB12 activated as the primary DB. Further, it is illustrated that a command for initialization “set_role(DB11, primary)system_start( )”, a command for an error injection “db_failover(DB11)”, and a command for rollback “db_failover(DB12)” are input, in this test. In addition, currently, the number of successes and the number of failures of the test are “0”, and in a case where the test is executed, the execution fee is “10 dollars”, the execution time is “10 minutes” for the error injection and “10 minutes” for the rollback. The determination of the success and the failure of the test, for example, may be performed in accordance with whether the executed processing is normally ended.

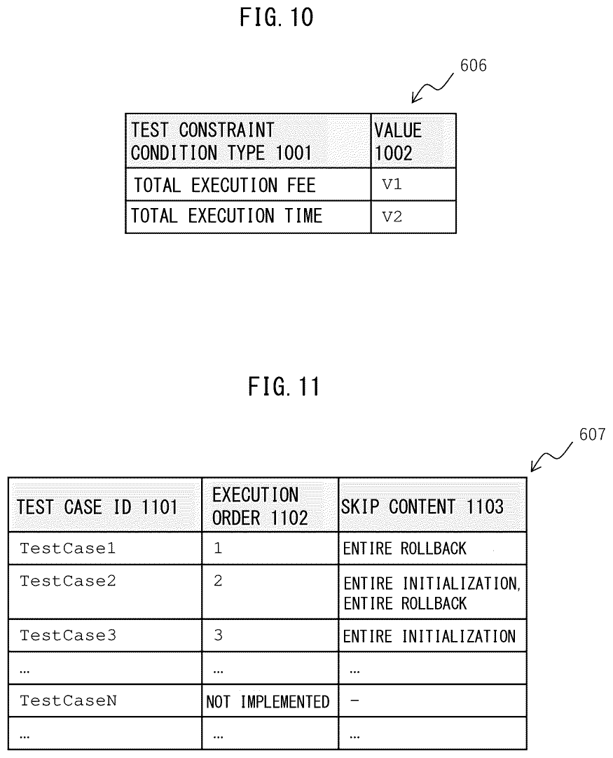

FIG. 10 is a diagram illustrating an example of the test constraint condition management table 606. The test constraint condition management table 606 is a table defining a condition to be a constraint on the execution of the test. As illustrated in FIG. 10, in the test constraint condition management table 606, a test constraint condition type 1001 indicating the type of condition of the constraint and a specific value 1002 of the type are stored in association with each other. FIG. 10, for example, illustrates that in a case where a test is executed on the IT system 101, “V1” is defined as the upper limit of the total execution fee, and “V2” is defined as the upper limit of the total execution time.

FIG. 11 is a diagram illustrating an example of the test case execution order management table 607. In the test case execution order management table 607, a test case ID 1101 similar to the test case ID 901 illustrated in FIG. 9, an execution order 1102 defining the execution order of the test case, and a skip content 1103 defining which state of the system or the resource is to be skipped are stored in association with each other. FIG. 11, for example, illustrates that a test case that is executed first is a test case identified by “TestCase 1”, and a content that is skipped in the test case is “entire rollback”. In addition, it is illustrated that a test case that is executed second is a test case identified by “TestCase 2”, and a content that is skipped in the test case is “entire initialization, entire rollback”. Further, it is illustrated that a test case that is executed third is a test case identified by “TestCase 3”, and a content that is skipped in the test case is “entire initialization”. In a case where such three test cases are executed, a transition is made as with the system state illustrated in FIG. 5.

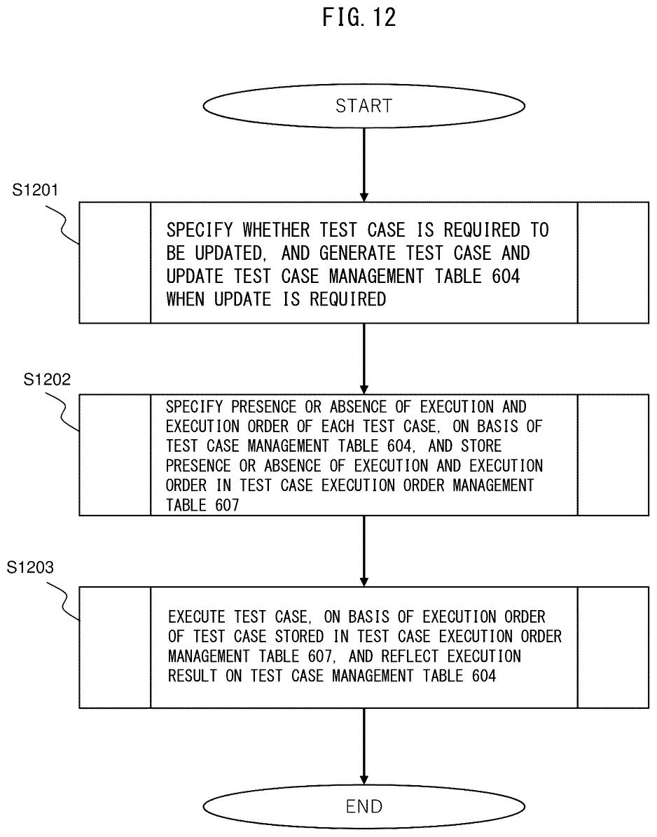

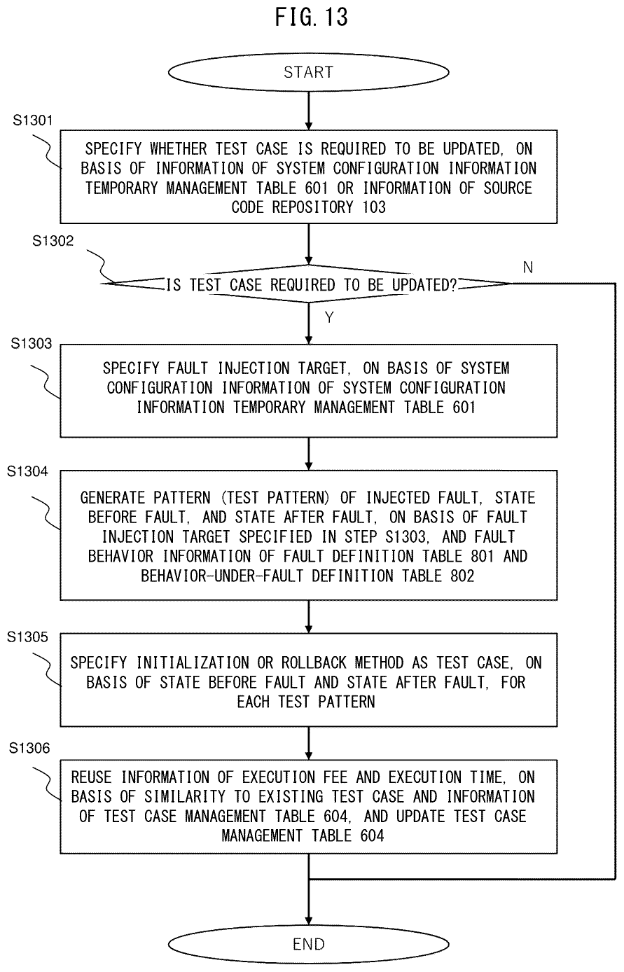

FIG. 12 is a flowchart illustrating an example of a processing procedure of processing executed by the management server 105 in this example. As illustrated in FIG. 12, in the management server 105, the test case generation unit 603 specifies whether the test case is required to be updated, and generates the test case and updates the test case management table 604 in a case where the update is required (S1201). The specific processing of S1201 will be described below by using FIG. 13.

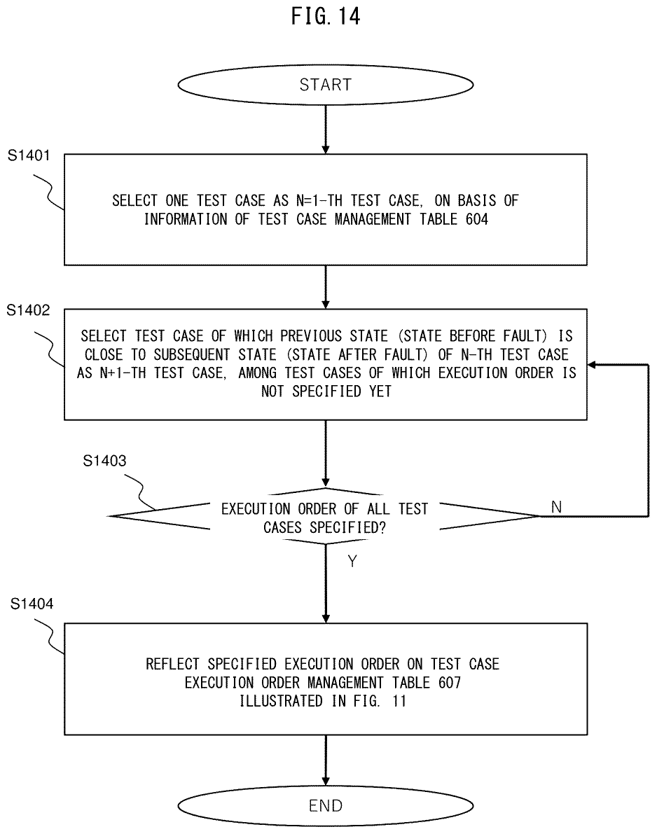

Subsequently, the test case execution order specification unit 605 specifies the presence or absence of the execution and the execution order of each test case, on the basis of the test case management table 604, and stores the presence or absence of the execution and the execution order in the test case execution order management table 607 (S1202). The specific processing of S1202 will be described below by using FIGS. 14 to 16.

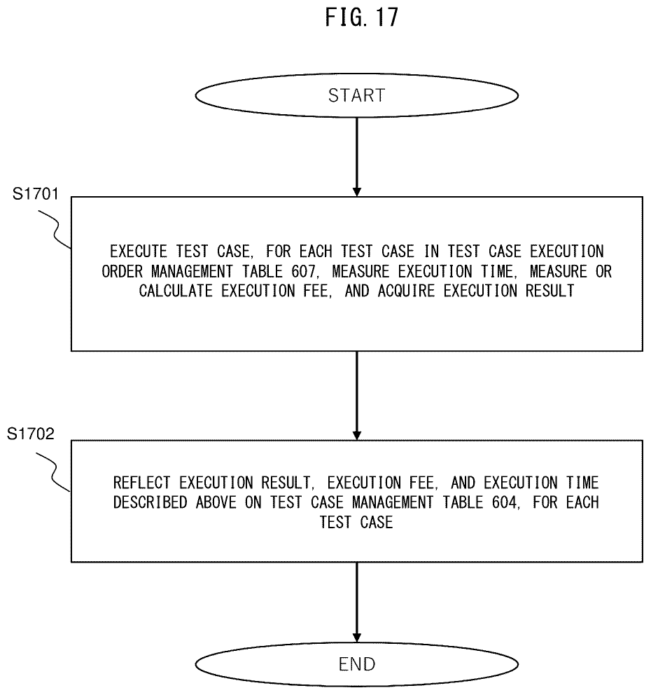

Subsequently, the test case is executed on the basis of the execution order of the test case that is stored by the test case execution unit 608 in the test case execution order management table 607, and an execution result is reflected on the test case management table 604 (S1203). The specific processing of S1203 will be described below by using FIG. 17.

FIG. 13 is a flowchart illustrating an example of a processing procedure of the detailed processing of S1201 illustrated in FIG. 12. As illustrated in FIG. 13, the test case generation unit 603 specifies and determines whether the test case is required to be updated, on the basis of the information of the system configuration information temporary management table 601 (FIG. 7) (S1301 and S1302). The information of the system configuration information temporary management table 601 is acquired from the IT system management server 102 or the source code repository 103. In a case where a record is stored in the system configuration information temporary management table 601 or in a case where a record is newly added, the test case generation unit 603 specifies the record, and determines that the test case is required to be updated.

In a case where it is determined that the test case is not required to be updated (S1302; No), the test case generation unit 603 ends this processing, and in a case where it is determined that the test case is required to be updated (S1302; Yes), the test case generation unit 603 proceeds to S1303.

The test case generation unit 603 specifies the fault injection target, on the basis of the system configuration information of the system configuration information temporary management table 601 (S1303). In FIG. 7, for example, the test case generation unit 603 specifies the resource “DB11” of which the resource type 702 belonging to the resource group 703 “DB Cluster 1” under the control of the area 704 “Zone 1, Region 1” is “DB” (database), as the fault injection target. Note that here, the case of performing the fault injection in DB unit will be described, but the fault injection may be performed in area unit.

The test case generation unit 603 generates a pattern (a test pattern) of the injected fault, the state before fault, and the state after fault, on the basis of the fault injection target specified in step S1303, and the fault behavior information of the fault definition table 801 (FIG. 8A) and the behavior-under-fault definition table 802 (FIG. 8B) (S1304). For example, for the resource “DB11” to be the fault injection target specified by using FIG. 7, the state before the fault injection, the injected fault, and the state after the fault injection corresponding to the resource type and the fault type illustrated in FIG. 8A and FIG. 8B are generated as one test pattern, and are set as one record of the test case management table 604 in FIG. 9. Each item of the tables illustrated in FIG. 8A and FIG. 8B has been already described, and thus, the description thereof will be omitted. For the system in the state before fault and the state after fault (“writing is being performed” and “writing is available”), a value according to the state is set.

Further, for each test pattern, the test case generation unit 603 specifies the initialization or rollback method as the test case, on the basis of the state before fault and the state after fault (S1305). For example, the test case generation unit 603 reads the fault definition table 801 in FIG. 8A, the behavior-under-fault definition table 802 in FIG. 8B, and the state acquisition setting method definition table 803 in FIG. 8C, and writes the execution content corresponding to the test pattern generated in S1304. Initialization 917 can be set from a setting method 844 in FIG. 8C, and an error injection 918 and rollback 919 can be set from a fault injection method in FIG. 8A.

The test case generation unit 603 reuses the information of the execution fee and the execution time, on the basis of similarity to the existing test case and the information of the test case management table 604, and updates the test case management table 604 (S1306). For example, the test case generation unit 603 determines whether the state before fault 903 and the state after fault 904 of the test case management table 604 are a similar content to a certain extent in the past record executed as the test case in S1305. Such determination may include the execution content 905. In the case of the similar content to a certain extent, the test case generation unit 603 determines that there is similarity to the past record, and sets the values of the items (for example, the execution fee 907 and the execution time 908) of the test case already written as the record as items of a record to be newly written. In a case where the processing of FIG. 13 is ended, the test case management table 604 illustrated in FIG. 9 is generated.

FIG. 14 is a flowchart illustrating an example of a processing procedure of the detailed processing of S1202 illustrated in FIG. 12. As illustrated in FIG. 14, the test case execution order specification unit 605 selects one test case as the N=1-th test case, on the basis of the information of the test case management table 604 (FIG. 9) generated in S1201 (S1401). The test case execution order specification unit 605, for example, selects the record of “TestCase 1” in the test case management table 604 illustrated in FIG. 9.

Subsequently, the test case execution order specification unit 605, among test cases of which the execution order is not specified yet, selects a test case of which the previous state (the state before fault) is close to the subsequent state (the state after fault) of the N-th test case as the N+1-th test case (S1402). The test case execution order specification unit 605, for example, selects a test case that is a record other than the record of “TestCase 1” selected in S1401, in which the state before fault 903 of the record is close to the state after fault 904 of the record of “TestCase 1”, as a test case of the next order (for example, the N=2-th test case). The close test case, for example, is a test case in which the state after fault 904 of the N-th test case is coincident with the state before fault 903 of the N+1-th test case. It is not necessary that the state after fault 904 of the N-th test case is coincident with the state before fault 903 of the N+1-th test case, and for example, at least a predetermined number of coincident roles or activation states may be included, or a case where there is semantic similarity to a certain extent may be regarded as coincidence. In this case, the test case execution order specification unit 605 may define the execution order of the test case in descending order of the degree of coincidence.

The test case execution order specification unit 605 determines whether the execution order of all the test cases is specified (S1403), and returns to S1402 and continuously specifies the execution order in a case where it is determined that the execution order of all the test cases is not specified (S1403; No).

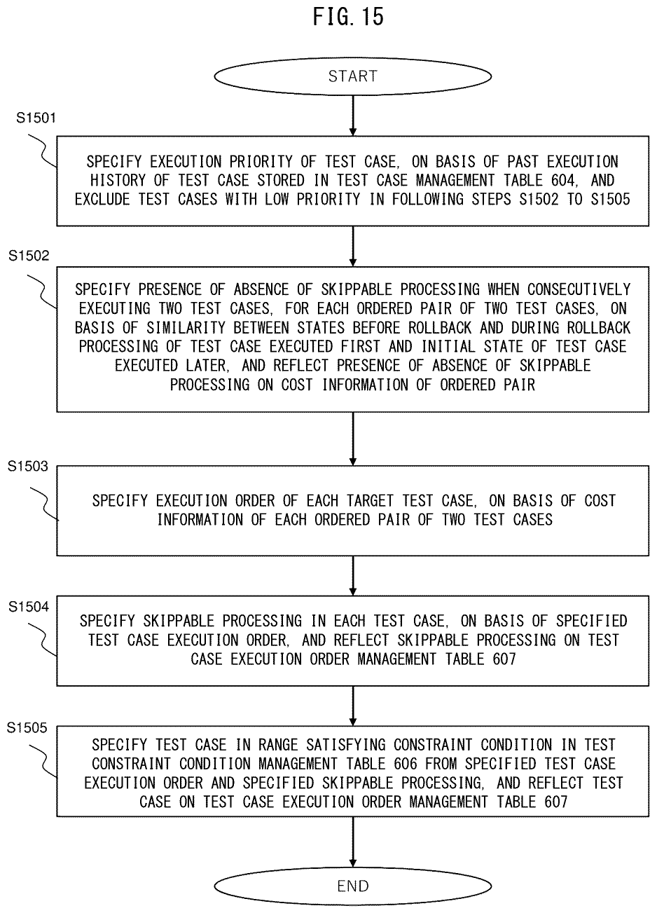

On the other hand, in a case where it is determined that the execution order of all the test cases is specified (S1403; Yes), the test case execution order specification unit 605 reflects the specified execution order on the test case execution order management table 607 illustrated in FIG. 11 (S1404). For example, the test case execution order specification unit 605 writes the execution order of “TestCase 1” as “1” and the execution order of “TestCase 2” as “2”, in the test case execution order management table 607. Further, the test case execution order specification unit 605 specifies the execution content 905 (for example, the processing of the initialization 917 and the rollback 919) of the test case selected as the close test case in S1402, as skippable processing, and writes the skippable processing in the skip content 1103 of the test case execution order management table 607 illustrated in FIG. 11. In a case where the processing of the S1404 is ended, the detailed processing of S1202 is ended. According to the processing procedure illustrated in FIG. 14, it is possible to define the execution order of the test case without imposing a processing load larger than that of a processing procedure illustrated in FIG. 15 described below.

FIG. 15 is a flowchart illustrating another example of the processing procedure of the detailed processing of S1202 illustrated in FIG. 12. As illustrated in FIG. 15, the test case execution order specification unit 605 specifies the execution priority of the test case, on the basis of the past execution history of the test case stored in the test case management table 604 illustrated in FIG. 9, and excludes test cases with low priority in the following steps S1502 to S1505 (S1501). For example, the test case execution order specification unit 605 determines that a test case of which the number of successes 920 of the history 906 is higher than a predetermined threshold value has low priority since there is less necessity of execute again the test case, and excludes the test case. Here, the exclusion is performed by using the number of successes 920, but in a case where the execution fee 907 is higher than a predetermined threshold value or in a case where the execution time 908 (an error injection 922 and rollback 923) is longer than a predetermined threshold value (that is, requires a long time), it may be determined that the priority is low, and the test case may be excluded. Further, the subsequent processing may be performed by sorting test cases that are not excluded, in ascending order of the number of successes 920, in ascending order of the execution fee 907, or in ascending order of the execution time 908. That is, the processing may be performed after reflecting the number of successes, the execution fee, and the execution time on the priority of the test case.

For example, as illustrated in FIG. 9, the test case management table 604 manages the success history or the failure history (a success 920 or a failure 921 in FIG. 9) of the execution of the past test, and thus, the test case execution order specification unit 605 may reflect the success history or the failure history stored as the execution result of the past test on the priority of the test case, and perform the sorting after excluding test cases of which the number of successes is higher than a predetermined threshold value and the number of failures does not satisfy a predetermined threshold value.

Subsequently, the test case execution order specification unit 605, for each ordered pair of two test cases selected from all the test cases (each execution order in the case of consecutively executing two test cases), specifies the presence of absence of the skippable processing when consecutively executing two test cases, on the basis of similarity between states before rollback (the state after fault) and during rollback processing of a test case that is executed first and the initial state (the state before fault) of a test case that is executed later, and reflects the presence of absence of the skippable processing on cost information of the ordered pair (S1502).

For example, a case is considered in which the test case execution order specification unit 605 selects the test case of “TestCase 3” illustrated in FIG. 9 as the test case that is executed first. In a case where a state in which “db_failover(DB12)” of the rollback 919 of the execution content 905 is executed (a state in which ap_start(AP) is not executed) that is the state after fault 904 to be the state before the rollback and the state during the rollback processing in the test case are coincident with the state before fault 903 that is the initial state of “TestCase 4” (not illustrated), which is the next test case, the test case execution order specification unit 605 determines that the test cases are similar to each other. Then, the test case execution order specification unit 605 specifies that the processing of “ap_start(AP)” performed in the coincident states is the skippable processing, and writes the test cases of “TestCase 3” and “TestCase 4”, which are the two test cases, in association with each other in a pair temporary management table 1600 for temporarily storing the two test cases. In this case, the test case execution order specification unit 605 writes a value according to the degree of similarity as the cost information in the pair temporary management table 1600. Here, in a case where the state after fault 904 before the rollback and the state during the rollback processing are coincident with the state before fault 903 of the next test case, a value according to the degree of similarity between the states is set as “0”, and it is defined such that the cost information decreases as the degree of similarity increases. As described above, it can be said that the cost information is an index indicating the similarity of the system state between two test cases.

In S1502, the cost information is defined in accordance with the degree of coincidence of the state. However, the cost information may be defined in accordance with either an execution time that is reduced in a case where two test cases are consecutively executed, a value based on whether some processing can be skipped in the consecutive execution (for example, the number of skippings), or an execution time in a case where the skippable processing is skipped in the consecutive execution.

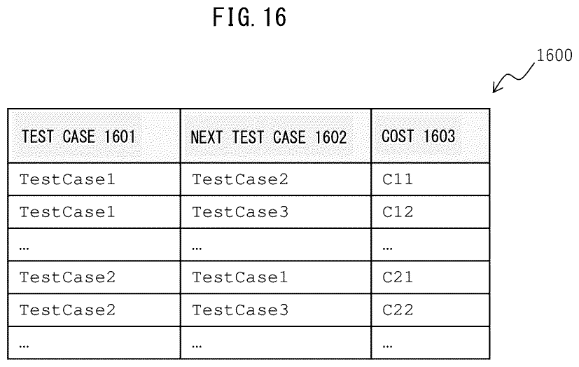

FIG. 16 is a diagram illustrating an example of the pair temporary management table 1600. As illustrated in FIG. 16, in the pair temporary management table 1600, a test case 1601 that is the test case described above, which is executed first, a next test case 1602 that is the next test case described above, and a cost 1603 that is the cost information described above are stored in association with each other.

Here, the similarity has been described by using the coincident states as an example. However, as with a case where the execution order is defined in S1402, it is not necessary that the states are coincident with each other, and for example, the states may be at least partially coincident with each other, or a case where there is semantic similarity to a certain extent may be regarded as coincidence. In this case, the test case execution order specification unit 605 may define the cost information in descending order of the degree of coincidence.

Returning to FIG. 15, the test case execution order specification unit 605 specifies the execution order of each target test case, on the basis of cost information of each ordered pair of two test cases (S1503). For example, the test case execution order specification unit 605 defines the execution order such that a pair with a smaller value of the cost information that is associated with a pair (a subset) of two test cases written in the pair temporary management table 1600 illustrated in FIG. 16 is executed first. In FIG. 16, in a case where cost information “C11” associated with a pair of “TestCase 1” and “TestCase 2” and cost information “C22” associated with a pair of “TestCase 2” and “TestCase 3” are smaller than the value of cost information corresponding to a pair of other test cases in this order, the test case is executed in order of “TestCase 1”, “TestCase 2”, and “TestCase 3”.

In this case, the test case execution order specification unit 605 may specify a subset of series of test cases not exceeding the upper limit of the total execution time (a high-order subset with a smaller cost in FIG. 16) in the test constraint condition management table 606 illustrated in FIG. 10 from the defined execution order of the test case, and define the execution order of the test case in ascending order of the total execution time. Similarly, the test case execution order specification unit 605 may specify a subset of series of test cases not exceeding the upper limit of the total execution fee (a high-order subset with a smaller cost in FIG. 16) in the test constraint condition management table 606 illustrated in FIG. 10 from the defined execution order of the test case, and define the execution order of the test case in ascending order of the total execution fee.

Subsequently, the test case execution order specification unit 605 specifies the skippable processing in each test case, on the basis of the specified test case execution order, and reflects the skippable processing on the test case execution order management table 607 (S1504). The specified skippable processing is processing specified in S1502. The test case execution order specification unit 605, for the test case of which the execution order is specified in S1503, writes the skippable processing specified in S1502 in the skip content 1103 of the test case execution order management table 607 illustrated in FIG. 11. For example, the test case execution order specification unit 605 writes the processing of “ap_start(AP)” (or the rollback 919) of “TestCase 3” that is specified as the skippable processing in S1502 in the skip content 1103.

Further, the test case execution order specification unit 605 specifies the test case in a range satisfying a constraint condition in the test constraint condition management table 606 from the test case execution order specified up to S1504 and the specified skippable processing, and reflects the test case on the test case execution order management table 607 (S1505).

For example, the test case execution order specification unit 605 limits the execution range of the test case such that the number of executed test cases increases while satisfying that the total execution fee is “V1” or less and the total execution time is “V2” or less, with reference to the execution order of the test case specified in S1503, the skippable processing specified in S1504, and the test constraint condition management table 606 illustrated in FIG. 10, and writes the result thereof in the test case execution order management table 607 to update the test case execution order management table. The determination of whether the total processing performed in each test case is the total execution fee or less and the total execution time or less may be performed from the execution fee 907 or the execution time 908 of the test case management table 604 illustrated in FIG. 9, or the like. The total execution fee and the total execution time stored in the test constraint condition management table 606 may be defined on the basis of test implementation requirements. In a case where the processing of S1505 is ended, the detailed processing in another example of S1202 is ended.

In the processing of FIG. 14 and FIG. 15, the execution order is specified in which the amount of time reduction due to the shortcut processing (the skipping of the processing) increases in order to reduce the total execution time of the test. FIG. 15 indicates that a directed graph is constructed in which the test case is regarded as a node and the consecutive execution between the test cases is regarded as a weighted edge. That is, the shortest path passing through all the nodes on the directed graph is determined as the path of the optimal execution order, that is, the execution order in which the amount of time reduction is maximized. For example, in FIG. 15, on the basis of the test execution history of the test case, unnecessary test cases are removed from an order search range, and then, the sameness of the “subsequent state” and the “previous state” between the test cases is determined, and in a case where it is determined that there is the sameness, the weight of the edge is decreased (for example, decreased by the amount of expected reduction in the execution time). Then, the approximate solution of the shortest path passing through all the test cases is specified by using a known technology, and whether the shortcut is available at each edge on the path is determined. Then, as “Node Passing Order =Test Case Execution Order”, in a case where it is determined that the shortcut is available, each test case is executed while skipping unnecessary processing, and then, the execution time or the like is measured, and the execution result is reflected on the history (for example, the number of successes of the test execution and the execution time of each processing).

FIG. 17 is a flowchart illustrating an example of a processing procedure of the detailed processing of S1203 illustrated in FIG. 12. As illustrated in FIG. 17, the test case execution unit 608, for each test case in the test case execution order management table 607 updated up to S1202, executes the test case, measures the execution time, measures or calculates the execution fee, and acquires the execution result. In the execution of the test case, in a case where there is the skippable processing, the skippable processing is skipped (S1701). The test case execution unit 608, for example, executes the test defined in the test case in order of the test cases “TestCase 1”, “TestCase 2”, and “TestCase 3” defined in the execution order 1102, and acquires the execution time, the execution fee, and the execution result thereof. The execution time, the execution fee, and the execution result can be acquired from a log in the test execution, and the fee may be obtained on the basis of a predetermined fee defined in advance.

Subsequently, the test case execution unit 608, for each test case, reflects the execution result, the execution fee, and the execution time of the processing of S1701 on the test case management table 604 (S1702). In a case where the processing of S1702 is ended, the detailed processing of S1203 is ended.

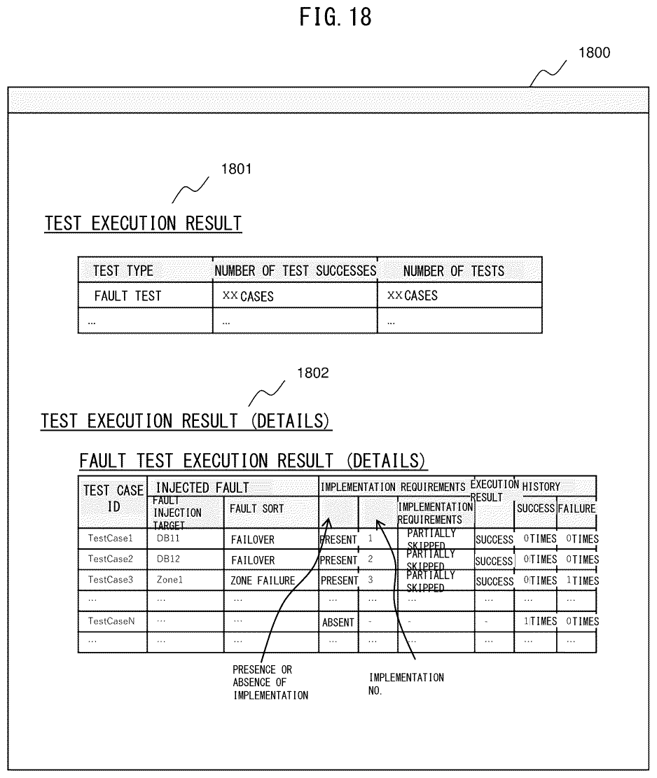

FIG. 18 is a diagram illustrating an example of a display screen output by this system. As illustrated in FIG. 18, a display screen 1800 includes a test execution result 1801 indicating the execution result of the test performed by the test case execution unit 608, and a test execution result (the details) 1802 indicating the details of the execution result of the test. In the test execution result 1801, a test type indicating which type of the test is performed, the number of test successes indicating the number of times when the test is successful, and the number of tests indicating the total number of successes and failures of the test are displayed in association with each other. In the test type, various types of tests including the fault test described in this example are displayed. The number of test successes may display the total number of successful test cases among the executed test cases, on the basis of the execution result acquired in S1701 illustrated in FIG. 17. In addition, the number of tests may display the total number of executed test cases.

In addition, for the items displayed in the test execution result (the details) 1802, each item of the test case management table 604 illustrated in FIG. 9 and each item of the test case execution order management table 607 illustrated in FIG. 11 are read out and displayed, and further, the execution result acquired in S1701 illustrated in FIG. 17 may be displayed.

As described above, according to this system, it is possible to make the suppression of a decrease in the number of executions of the test case and a reduction in the test execution time compatible.

Specifically, as described in FIG. 12, S1502 of FIG. 15, or the like, in an infrastructure test execution support system (for example, the management server 105) supporting the execution of a test relevant to the infrastructure of a system (for example, the IT system 101) that is executed by a computer (for example, the management server 105) including a processor and a memory, the processor specifies an execution order of two or more test cases (for example, the execution order 1102 in FIG. 11 that is based on the record in FIG. 16), on the basis of similarity information of a system state between two test cases, which is the similarity information between an intermediate state of the system in a first test case (for example, a state where the rollback 919 “db_failover(DB12)” of “TestCase 3” in FIG. 9 is executed (a state where ap_start(AP) is not executed)) and a previous state of the system in a second test case (for example, the state before fault 903 to be the initial state of “TestCase 4” (not illustrated)) (for example, the determination of whether the states are similar to each other, S1502 in FIG. 15). Accordingly, it is possible to specify the execution order of the test case, on the basis of the similarity between the previous state and the subsequent state of two test cases.

In addition, as described in each item of FIG. 9, or the like, the processor performs the specification, on the basis of the similarity information of the system state including one or more of (1) a state indicating whether a database of the system is a main configuration or a sub-configuration (the role in the state before fault and the state after fault of FIG. 9), (2) a state indicating whether writing to the system is available or writing is being performed (the systems 911 and 914 in the state before fault and the state after fault of FIG. 9), (3) a state indicating whether the database is being activated (the activation state in the state before fault and the state after fault of FIG. 9), and (4) the number of databases, as an element. Accordingly, it is possible to specify the execution order of the test case, in such specific system states.

In addition, as described in S1502 of FIG. 15, or the like, the processor defines an index indicating the similarity information of the system state between the two test cases (for example, the cost information in S1502 of FIG. 15), in accordance with either an execution time that is reduced when the two test cases are consecutively executed, a value based on whether some processing can be skipped in the consecutive execution, or an execution time when skippable processing is skipped in the consecutive execution. Accordingly, it is possible to determine the similarity, in accordance with the execution time or the reduced time of the test cases, the number of skippings, and the like.

In addition, as described in FIG. 15, each item of FIG. 9, or the like, the infrastructure test execution support system includes a test case management table (FIG. 9) for managing a time required for the rollback of the database in the system (for example, the rollback 923 of the execution time 908 in FIG. 9), and the processor performs the specification, on the basis of the similarity information between an intermediate state after a fault injection and rollback, as the intermediate state of the system in the first test case relevant to a fault test of the system, and the previous state of the system in the second test case relevant to the fault test of the system. Accordingly, it is possible to specify the execution order of the test case, on the basis of the similarity information between the intermediate state after the fault injection and the rollback in the first test case and the previous state of the system in the second test case, which are consecutive.

In addition, as described in each item of FIG. 9, FIG. 16, or the like, the infrastructure test execution support system includes the test case management table (FIG. 9) for managing an execution time of the test including the time required for the rollback (for example, the error injection 922 and the rollback 923 of the execution time 908 in FIG. 9), and a test constraint condition management table (FIG. 10) for managing the upper limit of the total execution time of the test, and the processor specifies a subset of series of test cases not exceeding the upper limit of the total execution time from the specified execution order of the test case (FIG. 16 and FIG. 11). Accordingly, it is possible to specify execution order of the test case in a range not exceeding the upper limit of the total execution time.

In addition, as described in each item of FIG. 9, FIG. 17, or the like, the infrastructure test execution support system includes the test case management table (FIG. 9) for managing an execution fee of the test (for example, the execution fee 907 in FIG. 9), and the processor calculates an execution fee of the specified test case, on the basis of a predetermined fee, and reflects the calculated execution fee on the test case management table and reflects the execution fee on the priority of the test case. Accordingly, it is possible to specify the execution order of the test case, in accordance with the execution fee of the test case.

In addition, as described in each item of FIG. 9, FIG. 16, or the like, the infrastructure test execution support system includes the test case management table (FIG. 9) for managing the execution fee of the test (for example, the execution fee 907 in FIG. 9), and the test constraint condition management table (FIG. 10) for managing the upper limit of the total execution fee of the test, and the processor specifies a subset of series of test cases not exceeding upper limit of the total execution fee from the specified execution order of the test case (FIG. 16 and FIG. 11). Accordingly, it is possible to specify the execution order of the test case in a range not exceeding the upper limit of the total execution fee.

In addition, as described in each item of FIG. 9, FIG. 16, or the like, the infrastructure test execution support system includes the test case management table (FIG. 9) for managing a success history or a failure history of the execution of a past test (for example, the success 920 and the failure 921 in FIG. 9), and the processor reflects an execution result of the past test on the success history or the failure history and reflects the success history or the failure history on the priority of the test case. Accordingly, it is possible to specify the execution order of the test case, on the basis of the success history or the failure history of the test.

In addition, as described in S1303 to 1306 of FIG. 13, or the like, the processor generates a test pattern for an injected fault, a state before fault, and a state after fault, on the basis of fault injection target included in a system configuration information temporary management table (FIG. 7) indicating the configuration of the system, a fault definition table (FIG. 8A) defining a fault in a resource of the system, and a behavior-under-fault definition table (FIG. 8B) defining the behavior of a resource into which a fault is injected, specifies a method for initializing the system or a rollback method of the database in the system to be the test case, on the basis of the state before fault and the state after fault in the generated test pattern, and when at least the state before fault and the state after fault are similar to a certain extent in a test of a past test case, sets an execution fee and an execution time of the similar test of the past test case as the execution fee and the execution time of the test of the specified test case to update the test case management table (for example, the execution fee 907 and the execution time 908 in FIG. 9). Accordingly, it is possible to define the execution fee and the execution time, on the basis of the performance of the past test case.

In addition, as described in FIGS. 11, 15, and 17, or the like, the infrastructure test execution support system includes a pair temporary management table (FIG. 16) for storing the specified execution order of the two or more test cases, and the processor, for the test case of the specified execution order, stores skippable processing between two consecutive test cases in the pair temporary management table, on the basis of the similarity information, and when the test case is executed, skips the skippable processing to execute the test, on the basis of information indicating the skippable processing. Accordingly, it is possible to execute the test by skipping the skippable processing between two consecutive test cases.

The invention is not limited to the embodiment described above as it is, and can be embodied by modifying the constituents within a scope not departing from the gist of the invention in the implementation stage, or can be carried out by suitably combining a plurality of constituents disclosed in the embodiment described above. For example, a plurality of management servers 105 may be provided, the tests of the test cases described in the examples may be executed in parallel in such a plurality of environments, the execution order of all the test cases may be specified in each environment, and then, the execution order may be defined for a pair (a subset) of two test cases stored in the pair temporary management table 1600 illustrated in FIG. 16 such that the estimated execution times of the tests are approximately the same. For example, the estimated execution times of the tests may be averaged in each of the management servers 105 by replacing the subset stored in one management server 105 with the subset stored in another management server 105.

What is claimed is:

1. An infrastructure test execution support system that is executed by a computer including a processor and a memory and supports execution of a test relevant to an infrastructure of a system,
wherein the processor specifies an execution order of two or more test cases, on the basis of similarity information of a system state between two test cases, which is the similarity information between an intermediate state of the system in a first test case and a previous state of the system in a second test case.

2. The infrastructure test execution support system according to claim 1,
wherein the processor performs the specification, on the basis of the similarity information of the system state including one or more of (1) a state indicating whether a database in the system is a main configuration or a sub-configuration, (2) a state indicating whether writing to the system is available or writing is being performed, (3) a state indicating whether the database is being activated, and (4) the number of databases, as an element.

3. The infrastructure test execution support system according to claim 1,
wherein the processor defines an index indicating the similarity information of the system state between the two test cases, in accordance with either an execution time that is reduced when the two test cases are consecutively executed, a value based on whether some processing can be skipped in the consecutive execution, or an execution time when skippable processing is skipped in the consecutive execution.

4. The infrastructure test execution support system according to claim 1,
wherein the system includes a test case management table for managing a time required for rollback of a database in the system, and
the processor performs the specification, on the basis of the similarity information between an intermediate state after a fault injection and rollback, as the intermediate state of the system in the first test case relevant to a fault test of the system, and the previous state of the system in the second test case relevant to the fault test of the system.

5. The infrastructure test execution support system according to claim 4,
wherein the system includes the test case management table for managing an execution time of the test including the time required for the rollback, and a test constraint condition management table for managing an upper limit of a total execution time of the test, and
the processor specifies a subset of series of test cases not exceeding the upper limit of the total execution time from the specified execution order of the test case.

6. The infrastructure test execution support system according to claim 4,
wherein the system includes the test case management table for managing an execution fee of the test, and
the processor calculates an execution fee of the specified test case, on the basis of a predetermined fee, and reflects the calculated execution fee on the test case management table and reflects the execution fee on priority of the test case.

7. The infrastructure test execution support system according to claim 4,
wherein the system includes the test case management table for managing an execution fee of the test, and a test constraint condition management table for managing an upper limit of a total execution fee of the test, and
the processor specifies a subset of series of test cases not exceeding the upper limit of the total execution fee from the specified execution order of the test case.

8. The infrastructure test execution support system according to claim 4,
wherein the system includes the test case management table for managing a success history or a failure history of execution of a past test, and
the processor reflects an execution result of the past test on the success history or the failure history and reflects the success history or the failure history on priority of the test case.

9. The infrastructure test execution support system according to claim 4,
wherein the processor
generates a test pattern for an injected fault, a state before fault, and a state after fault, on the basis of a fault injection target included in a system configuration information temporary management table indicating a configuration of the system, a fault definition table defining a fault in a resource of the system, and a behavior-under-fault definition table defining behavior of the resource into which a fault is injected,
specifies a method for initializing the system or a rollback method of the database in the system to be the test case, on the basis of the state before fault and the state after fault in the generated test pattern, and
when at least the state before fault and the state after fault are similar to a certain extent in a test of a past test case, sets an execution fee and an execution time of the similar test of the past test case as an execution fee and an execution time of the test of the specified test case to update the test case management table.

10. The infrastructure test execution support system according to claim 1,
wherein the system includes a pair temporary management table for storing the specified execution order of the two or more test cases, and
the processor
stores, for the test case of the specified execution order, skippable processing between two consecutive test cases in the pair temporary management table, on the basis of the similarity information, and
when the test case is executed, skips the skippable processing to execute the test, on the basis of information indicating the skippable processing.

11. An infrastructure test execution support method that is executed by a computer including a processor and a memory and supports execution of a test relevant to an infrastructure of a system,
wherein the computer specifies an execution order of two or more test cases, on the basis of similarity information of a system state between two test cases, which is the similarity information between an intermediate state of the system in a first test case and a previous state of the system in a second test case.
